(19) United States
(12) Patent Application Publication
(10) Pub. No.: US 2003/0229189 A1
(43) Pub. Date: Dec. 11, 2003

(54) Nanoporous random glassy polymers

(76) Inventors: Kazuya Takayama, Phoenixville, PA (US); Yu-Ling Hsiao, Collegeville, PA (US); Renyuan Gao, Wayne, PA (US); Anthony F. Garito, Radnor, PA (US)

Correspondence Address: Finnegan, Henderson, Farabow,, Garrett & Dunner, L.L.P., 1300 I Street, N.W., Washington, DC, 20005-3315, US

(21) Appl. No.: 10/359,725

(22) Filed: Feb. 7, 2003

Related U.S. Application Data
(60) Provisional application No. 60/355,399, filed on Feb. 7, 2002.

(51) Int. Cl. C08G 18/00; C08F 12/20

(52) U.S. Cl. 526/242; 528/44

(57) ABSTRACT

The present invention discloses a class of random glassy polymer materials, namely nanoporous polymer materials, which contain pores with dimensions ranging from about 1 nm to about 1000 nm. The present invention also discloses a method of making a nanoporous polymer material by controlling the size, shape, volume fraction, and topological features of the pores, which comprises annealing the polymer material at a temperature above its glass transition temperature. The present invention further discloses the use of the resulting nanoporous polymer material to make devices, such as optical devices. For example, the resulting nanoporous polymer can be used to make a planar waveguide that can exhibit an optical loss of less than 0.5 dB/cm.

### CROSS-REFERENCE TO RELATED APPLICATION

This application claims the benefit of priory under 35 U.S.C. §119(e) to U.S. Provisional Application No. 60/355,399 filed Feb. 7, 2002.

### FIELD OF THE INVENTION

The present invention is related to nanoporous random glassy polymer materials. The present invention is also related to methods of making such materials by controlling the topological features of the pores in these random glassy materials. In addition, the present invention is related to articles, such as optical articles, and in particular, optical waveguides, wherein the articles are formed by nanoporous random glassy materials that can exhibit various desirable features, such as low optical loss.

### BACKGROUND OF THE INVENTION

It is generally desirable that in an optical component, such as a planar optical waveguide, an optical fiber, an optical film, or a bulk optical component, e.g., an optical lens or prism, the total optical loss be kept at a minimum. For example, in the case of a planar optical wavegide, the total loss should be approximately equal to, or less than, 0.5 dB/cm in magnitude, and such as less than 0.2 dB/cm. For a highly transparent optical medium to be used as the optical material, a fundamental requirement is that the medium exhibits little, or no, absorption and scattering losses. Intrinsic absorption losses commonly result from the presence of fundamental excitations that are electronic, vibrational, or coupled electronic-vibrational modes in origin. Further, the device operating wavelength of the optical component should remain largely different from the fundamental, or overtone, wavelengths for these excitations, especially in the case of the telecommunication wavelengths of 850, 1310, and 1550 nm located in the low loss optical window of a standard silica glass optical fiber, or waveguide. Material scattering losses occur when the signal wave encounters abrupt changes in refractive index of the otherwise homogeneous uniform optical medium. These discontinuities can result from the presence of composition inhomogenieties, crystallites, microporous structures, voids, fractures, stresses, faults, or even foreign impurities such as dust or other particulates.

Among the various mechanisms of optical scattering loss, an important factor is the porosity of the optical material. As a result of the interplay between various material characteristics, e.g., surface energy, solubility, glass temperature, entropy, etc., and processing conditions, e.g. temperature, pressure, atmosphere, etc., optical materials, such as amorphous perfluoropolymers can exhibit a large amount of microporous structures under normal processing conditions. Such microporous structures can cause optical scattering loss and should be eliminated, or converted to smaller sizes, in order to satisfy a certain low optical loss device performance requirement. The smaller sized pores are called nanopores. Nanopores are pores in a material that have a size measured on a nanometer scale. Generally, nanopores are larger than the size of an atom but smaller than 1000 nm. While most nanopores have a size from about 1 nm to about 500 nm, the term nanopores can cover pores having sizes that fall outside of this range. For example, pores having a size as small as about 0.5 nm and as large as about 1×10³ nm could still be considered nanopores

By controlling the pore sizes and pore structures, optical scattering losses can be greatly reduced. For discrete nanopores that are approximately spherical in shape and are evenly distributed into a host matrix, the scattering loss a, in dB per unit length, resulting from the presence of the nanopores, is dependent on the pore diameter d, the refractive index ratio of the pores and the surrounding host material m=nₚₒᵣ/nₛᵤᵣ, and the volume fraction of the nanopores in the host Vₚ. The nanopore induced scattering loss can be calculated by:

$$α = 1.692 \times {10}^{3} ( \frac{{m}^{2} - 1}{{m}^{2} + 2} ) \frac{{d}^{3} {V}_{p}}{{λ}^{4}} \qquad ( 1 )$$

wherein λ is the vacuum propagation wavelength of the light guided inside the waveguide. As an example, when m=1.3, Vₚ=10%, λ=1550 nm, d=10 nm, the calculated scattering loss α is 0.001 dB/cm. To fabricate a certain optical component with a set loss specification, and therefore a nanopore induced scattering loss budget of a, the nanopore diameter d satisfies the following relationship:

$$d < {( α \frac{1}{1.692 \times {10}^{3}} {( \frac{{m}^{2} + 2}{{m}^{2} - 1} )}^{2} \frac{{λ}^{4}}{{V}_{p}} )}^{1 / 3} \qquad ( 2 )$$

wherein λ is the vacuum propagation wavelength of the light guided inside the waveguide, m=nₚₒᵣ/nₛᵤᵣ the refractive index ratio of the nanopores and the host material, and Vₚ the volume fraction of the nanopores in the host material. For example, following Equation 2, with a nanopore loss budget of α=0.5 dB/cm, when m=1.3, Vₚ=10%, λ=1550 nm, the nanopore diameter d must be smaller than 37 nm. In general, the diameter of the nanopores should be smaller than 100 nm, and such as smaller than 50 nm.

The host matrix may be comprised of a random glassy matrix such as an inorganic glass, or organic polymer. Suitable inorganic glass hosts include, but are not limited to, doped and undoped silica such as aluminosilicate glasses, silica, germania-silica, lithium-alumina-silica, sulfide glasses, phosphate glasses, halide glasses, oxide glasses, and chalcogenide glasses. Organic polymers may include typical hydrocarbon polymers and halogenated polymers.

Nanoporous materials comprising nanopores distributed within a host matrix material may be used in optical applications. For example, in a waveguide structure comprised of a uniform square, or circular, waveguide cross-section, the waveguide material should exhibit little, or no, optical attenuation, or loss, in signal propagation through the material. A potential source for loss dependent behavior are material scattering centers such as relatively extensive pore or void structures present in the waveguide material.

Thus, nanopores can be distributed in the host matrix in great numbers as separate individual pores, or as joined clusters, some even extending as a continuous interconnected network-like structure over the entire material sample, thereby forming a nanoporous structure.

Clustering of the nanopores within the host matrix material may result in a porous material that lacks a desired characteristic. Specifically, when nanopores fuse together, the larger nanoporous structures formed may not behave in a similar way to the smaller nanopores. For example, while nanopores may be small enough to avoid scattering light within the matrix material, fused pores may be sufficiently large to cause scattering. As a result, a host matrix material may become substantially less transparent in the presence of such nanoporous structures.

Thus, for example, of many potential host matrix polymer materials, halogenated polymers have been shown to have potential to be used in the optical field. Halogenated polymers, such as fluoropolymers, are well known to be problematic toward pore-like structures. However, in the optical field, the presence of such porous structures, especially on nanometer length scales, in thin films and fibers of these halogenated polymers can ultimately cause light to scatter in optical waveguides from these thin films and fibers, thereby resulting in significant optical signal attenuation. To achieve lower optical loss, it is, therefore, important to control the size and distribution of the nanoporous structures.

The present invention can overcome one or more of the above-described problems or disadvantages associated with the prior art.

### SUMMARY OF THE INVENTION

The present invention discloses a class of random glassy polymer materials, namely nanoporous polymer materials, which contain pores with dimensions ranging from 1 nm to 1000 nm. The present invention also discloses a method of making a nanoporous polymer material by controlling the size, shape, volume fraction, and topological features of the pores, which comprises annealing the polymer material at a temperature above its glass transition temperature. The present invention further discloses the use of the resulting nanoporous polymer material to make devices, such as optical devices. For example, the resulting nanoporous polymer can be used to make a planar waveguide that can exhibit an optical loss of less than 0.5 dB/cm.

### BRIEF DESCRIPTION OF THE DRAWINGS

In the drawings:

FIGS. 1A-1D indicate the solvent weight loss in terms of time at annealing temperature of 40° C., 60° C., 80° C., and 100° C., respectively in Example 1.

FIG. 2A is an Atomic Force Microscope (AFM) photo of the fluoropolymer, without the densification process and exhibiting large pore sizes.

FIGS. 2B-2E are Atomic Force Microscope (AFM) photos of the fluoropolymers, which are prepared according to Examples 1, 2, and 3, respectively. The pore sizes are greatly reduced from those in FIG. 2A.

FIG. 3 illustrates an annealing profile that is optimized by monitoring the solvent removal rate through the thermalgravimetric method.

FIG. 4 shows the loss spectrum of a low loss polymer waveguide fabricated with the densification procedure described in Example 3.

FIG. 5 shows an apparatus for measuring slab waveguide loss.

FIG. 6 shows a measured loss of a densified polymer optical slab waveguide.

FIG. 7 shows the shape and structure of a polymer optical channel waveguide that can be made with the disclosed nanoporous polymer materials.

FIG. 8(a) through (c) shows the shape and structure of other optical devices, such as optical fibers, optical prisms, and optical lenses, that can be made with the disclosed nanoporous polymer materials.

FIG. 9 is a cross-sectional contour of FIG. 2A.

FIG. 10 is a cross-sectional contour of FIG. 2B.

### DETAILED DESCRIPTION OF THE INVENTION

In the following description, reference is made to the accompanying drawings that form a part thereof, and in which is shown by way of illustration specific exemplary embodiments in which the invention can be practiced. These embodiments are described in sufficient detail to enable those skilled in the art to practice the invention, and it is to be understood that other embodiments can be utilized and that changes can be made without departing from the scope of the present invention.

Disclosed herein is a process of making an optical polymer comprising densifying a fluoropolymer from a solution comprising the fluoropolymer and at least one solvent, wherein the densified fluoropolymer exhibits a low optical loss.

As disclosed herein, the term “densifying” means removing or eliminating at least one nanoporous structure intrinsically existing in the fluoropolymer film by a densification process described below.

Further as disclosed herein, the term “optical polymer” means a polymer or a polymeric composition, which is applicable to be used in the optical field, such as to make an optical device. Optical devices include, for example, passive waveguides, active waveguides, fibers, lens, pellicles, coatings, and displays. The optical polymer can be, for example, suitable for transmitting light in optical waveguides and for other optical applications. In general, the optical polymer according to the present invention can exhibit a low optical loss less than about 1 dB/cm, such as less than about 0.5 dB/cm, and further such as less than about 0.1 dB/cm.

Even further as disclosed herein, the term “optical loss,” including both absorption loss and scattering loss, means a slab waveguide loss, which can be measured according to a process commonly known to one of ordinary skill in the art, for example, the process disclosed in Chia-Chi Teng, Precision Measurements of the Optical Attenuation Profile along the Propagation Path in Thin-film Waveguides, APPLIED OPTICS, vol. 32, No. 7, Mar. 1, 1993, pages 1051-1054.

In one embodiment, the random glassy matrix may comprise at least one polymeric entity chosen from polymers, copolymers, and terpolymers.

In another embodiment, the random glassy matrix can comprise at least one halogenated polymer, such as a halogenated elastomer, a perhalogenated elastomer, a halogenated plastic, or a perhalogenated plastic, either by itself, or in a blend with other matrix material listed herein.

In yet another embodiment, the random glassy matrix may comprise at least one polymeric entity chosen from polymers, copolymers, and terpolymers comprising at least one halogenated monomer represented by one of the following formulas:

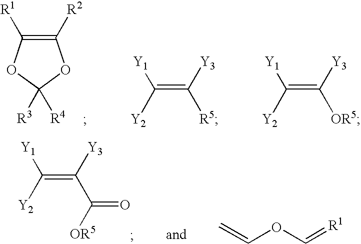

wherein R¹, R², R³, R⁴, and R⁵, which may be identical or different, are each chosen from linear and branched hydrocarbon-based chains, possibly forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane. Y₁ and Y₂, which may be identical or different, are each chosen from H, F, Cl, and Br atoms. Y₃ is chosen from H, F, Cl, and Br atoms, CF₃, and CH₃.

Alternatively, the polymers, copolymers, and terpolymers may comprise a condensation product made from the monomers listed below:

HO—R—OH+NCO—R′—NCO; or

HO—R—OH+Ary¹-Ary²,

wherein R, R′, which may be identical or different, are each chosen from halogenated alkylene, halogenated siloxane, halogenated ether, halogenated silylene, halogenated arylene, halogenated polyether, and halogenated cyclic alkylene. Aryl, Ary², which may be identical or different, are each chosen from halogenated aryls and halogenated alkyl aryls.

Ary as used herein, is defined as being a saturated, or unsaturated, halogenated aryl, or a halogenated alkyl aryl group.

Alternatively, the random glassy matrix can comprise at least one polymeric entity chosen from halogenated cyclic olefin polymers, halogenated cyclic olefin copolymers, halogenated polycyclic polymers, halogenated polyimides, halogenated polyether ether ketones, halogenated epoxy resins, halogenated polysulfones, and halogenated polycarbonates.

The random glassy matrix, for example, a fluorinated polymer host matrix, may exhibit very little absorption loss over a wide wavelength range. Therefore, such fluorinated polymer materials may be suitable for optical applications.

In one embodiment, at least one of the halogenated aryl, alkyl, alkylene, alkylene ether, alkoxy, siloxane, ether, polyether, thioether, silylene, and silazane groups is partially halogenated, meaning that at least one hydrogen in the group has been replaced by a halogen. In another embodiment, at least one hydrogen in the group may be replaced by fluorine. Alternatively, at least one of the aryl, alkyl, alkylene, alkylene ether, alkoxy, siloxane, ether, polyether, thioether, silylene, and silazane groups may be completely halogenated, meaning that each hydrogen of the group has been replaced by a halogen. In an embodiment, at least one of the aryl, alkyl, alkylene, alkylene ether, alkoxy, siloxane, ether, polyether, thioether, silylene, and silazane groups may be completely fluorinated, meaning that each hydrogen has been replaced by fluorine. Furthermore, the alkyl and alkylene groups may comprise from 1 and 12 carbon atoms.

Additionally, the random glassy matrix may comprise a combination of one or more different halogenated polymers, such as fluoropolymers, blended together. Further, the random glassy matrix may also comprise at least one other polymer, such as halogenated polymers comprising at least one functional group such as phosphinates, phosphates, carboxylates, silanes, siloxanes, sulfides, including POOH, POSH, PSSH, OH, SO₃H, SO₃R, SO₄R, COOH, NH₂, NHR, NR₂, CONH₂, and NH-NH₂, wherein R may comprise at least one group chosen from aryl, alkyl, alkylene, siloxane, silane, ether, polyether, thioether, silylene, and silazane groups. Further, the random glassy matrix may also comprise at least one entity chosen from homopolymers and copolymers of vinyl, acrylate, methacrylate, vinyl aromatic, vinyl esters, alpha beta unsaturated acid esters, unsaturated carboxylic acid esters, vinyl chloride, vinylidene chloride, and diene monomers. Further, the random glassy matrix may also comprise a hydrogen-containing fluoroelastomer, a hydrogen-containing perfluoroelastomer, a hydrogen containing fluoroplastic, a perfluorothermoplastic, at least two different fluoropolymers, or a cross-linked halogenated polymer.

Examples of the random glassy matrix include: poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, fluorinated Nafion®, fluorinated poly(phenylenevinylene), polyfluoroacrylates, fluorinated polycarbonates, perfluoro-polycyclic polymers, polymers of fluorinated cyclic olefins, or copolymers of fluorinated cyclic olefins.

By including at least one halogen atom, such as at least one fluorine, into the random glassy matrix, the optical properties of polymer matrix and the resulting nanocomposite material from the process as disclosed herein can be improved over conventional nanocomposite materials. Unlike the C—H bonds of hydrocarbon polymers, carbon-to-halogen bonds (such as C—F) shift the vibrational overtones toward longer wavelengths out of the ranges used in telecommunication applications. For example, the carbon-to-halogen bonds exhibit vibrational overtones having low absorption levels ranging, especially the telecommunication wavelengths around 850, 1310, and 1550 nm from about 0.8 μm to about 0.9 μm, and ranging from about 1.2 μm to 1.7 μm. As hydrogen is removed through partial to total halogenation, the absorption of light by vibrational overtones is reduced. One parameter that quantifies the amount of hydrogen in a polymer is the molecular weight per hydrogen for a particular monomeric unit. For highly halogenated polymers useful in optical applications, this ratio may be about 10 to 100 or greater. This ratio can approach infinity for perhalogenated materials.

Examples of the fluoropolymer include poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, perfluorosulfonate ionomer, such as fluorinated Nafion®, and fluorinated poly(phenylenevinylene).

In one embodiment, the fluoropolymer is chosen from perfluoropolymers. For example, the fluoropolymer is poly(cyclo-perfluorobutenyl vinyl ether).

Additionally, the random glassy matrix may comprise any polymer sufficiently clear for optical applications. Examples of such polymers include polymethylmethacrylates, polystyrenes, polycarbonates, polyimides, epoxy resins, cyclic olefin copolymers, cyclic olefin polymers, acrylate polymers, PET, polyphenylene vinylene, polyether ether ketone, poly (N-vinylcarbazole), acrylonitrile-styrene copolymer, and poly(phenylenevinylene). The random glassy matrix may also be nanocomposites with nanoparticles distributed within the host matrix.

Nanoporous matrixes may comprise various different materials, and may be produced by several different methods. In one embodiment of the invention, the nanoporous structures are produced in a phase inversion process. In standard practice, a spinodal phase diagram, plotting temperature vs. concentration for a hypothetical random glassy polymer-liquid system, can guide the selection of the concentration required to form the nanoporous structure and to utilize the methods of the present invention. Thus, standard spin coating and casting of a polymer-liquid system can provide a direct method for realizing phase inversion and consequent porous structures in the final spun polymer thin film.

In an embodiment of the present invention, nanopores have a major dimension of less than about 50 nm. That is, the largest dimension of the nanopores (for example the diameter in the case of a spherically shaped particle) is less than about 50 nm. Other processes can also lead to nanopores of the present invention. For example, nanoporous structures can be fabricated by polymer melt processes and nuclear bombardment method.

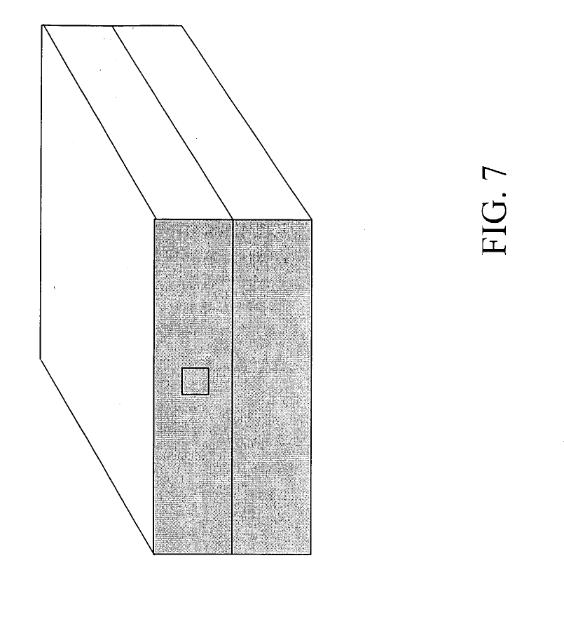

Referring to FIG. 7, an optical waveguide assembly is comprised of a polymer substrate with a polymer optical waveguide disposed on the substrate. The waveguide is comprised of a lower cladding, a core disposed on at least a portion of the lower cladding, and an upper cladding disposed on the core and a remaining portion of the lower cladding. The lower cladding, the core, and the upper cladding are all polymers, and advantageously all perhalogenated polymers, including, for example, perfluoropolymers.

In one embodiment, the substrate is, for example, chosen from polycarbonate, acrylic, polymethyl methacrylate, cellulosic, thermoplastic elastomer, ethylene butyl acrylate, ethylene vinyl alcohol, ethylene tetrafluoroethylene, fluorinated ethylene propylene, polyetherimide, polyethersulfone, polyetheretherketone, polyperfluoroalkoxyethylene, nylon, polybenzimidazole, polyester, polyethylene, polynorbornene, polyimide, polystyrene, polysulfone, polyvinyl chloride, polyvinylidene fluoride, ABS polymers, polyacrylonitrile butadiene styrene, acetal copolymer, poly[2,2-bistrifluoromethyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], and any other thermoplastic polymers; and thermoset polymers, such as diallyl phthalate, epoxy, furan, phenolic, thermoset polyester, polyurethane, and vinyl ester. However, those skilled in the art will recognize that a blend of at least two of the polymers listed above, or other polymers, can be used. For example, the substrate is circular and is ranging approximately from 7.5 to 15 centimeters (3 and 6 inches) in diameter.

In another embodiment, the lower cladding is, for example, chosen from halogenated polymers, such as fluoropolymers, and further such as perfluoropolymers, including, for example, poly[2,2-bistrifluoromethyl-4,5-difluoro-1,3-dioxole-co-tetrafluoroethylene], poly[2,3-(perfluoroalkenyl) perfluorotetrahydrofuran], and poly[2,2,4-trifluoro-5-trifluoromethoxy-1,3-dioxole-co-tetrafluoroethylene]. Those skilled in the art should recognize that other polymers or polymer blends can also be used for the lower cladding.

The core is, for example, chosen from polymers, such as halogenated polymers, and further such as perfluoropolymers. The upper cladding is, for example, chosen from polymers, such as halogenated polymers, and further such as perfluoropolymers. In one embodiment, the upper cladding is the same polymer or polymer blend as the lower cladding. However, those skilled in the art will recognize that the upper cladding and the lower cladding need not necessarily be the same polymer, although it is preferred that the upper cladding have the same, or nearly the same, refractive index n_{cl} as the lower cladding.

In yet another embodiment, the lower cladding and the upper cladding have a common refractive index n_{co} and the core has a refractive index nco that differs from the refractive index n_{cl} by a small enough amount such that the waveguide assembly propagates a signal light λ_{S} in a single mode. For the case where the cladding layers are homogeneous, with a single refractive index n_{cl} the relationship between dimensions of the core and Δn (n_{co}-n_{cl}) is well-captured by the dimensionless V parameter, defined by:

$$V = \frac{2 π}{λ} a \sqrt{Δ n} \qquad ( 3 )$$

wherein λ is the wavelength, such as in nanometers, of light to be transmitted through the core and a is the width of the core, such as in nanometers. The parameter V should be less than 2.5 in order to achieve the single-mode condition. When Δn is large, a should be kept small to achieve V<2.5. Such a requirement may result in low optical efficiency coupling to an optical fiber, resulting in undesired signal loss. For a V of 2.5, with An of approximately 0.04, at a wavelength λ of 1550 nanometers, a is approximately 3000 nanometers, or 3 microns.

To manufacture the waveguide assembly, the substrate is first prepared. The surface of the substrate is cleaned to remove any adhesive residue which may be present on the surface of the substrate. Typically, a substrate is cast or injection molded, providing a relatively smooth surface on which it can be difficult to deposit a perfluoropolymer, owing to the non-adhesive characteristics of perfluoropolymers in general. After cleaning, the substrate is prepared to provide better adhesion of the lower cladding to the surface of the substrate. The substrate can be prepared by roughening the surface or by changing the chemical properties of the surface to better retain the perfluoropolymer comprising the lower cladding layer. One example of the roughening method is to perform reactive ion etching (RIE) using argon. The argon physically deforms the surface of the substrate, generating a desired roughness of approximately 50 to 100 nanometers in depth. One example of the method that can change the chemical properties of the surface of the substrate is to perform RIE using oxygen. The oxygen combines with the polymer comprising the surface of the substrate, causing a chemical reaction on the surface of the substrate and oxygenating the surface of the substrate. The oxygenation of the substrate can allow the molecules of the perfluoropolymer comprising the lower cladding to bond with the substrate. Those skilled in the art will recognize that other methods can also be used to prepare the substrate.

The lower cladding is then deposited onto the substrate. For a lower cladding constructed from poly[2,2,4-trifluoro-5-trifluoromethoxy-1,3-dioxole-co-tetrafluoroethylene], solid poly[2,2,4-trifluoro-5-trifluoromethoxy-1,3-dioxole-co-tetrafluoroethylene] is dissolved in a solvent, perfluoro (2-butyltetrahydrofuran), which is sold under the trademark FC-75, as well as perfluoroalkylamine, which is sold under the trademark FC-40. Other potential solvents are a perfluorinated polyether, such as that sold under the trademark H GALDEN® series HT170, or a hydrofluoropolyether, such as that sold under the trademarks H GALDEN® series ZT180 and ZT130. For a lower cladding constructed from other polymers, each polymer is dissolved in a suitable solvent to form a polymer solution. The polymer solution is then spin-coated onto the substrate using known spin-coating techniques. The substrate and the lower cladding are then heated to evaporate the solvent from the solution.

In one embodiment, the lower cladding is spin-coated in layers, such that a first layer is applied to the substrate, baked to evaporate the solvent, and annealed to densify the polymer, a second layer is applied to the first layer and densified, and a third layer is applied to the second layer and densified . For example, after all of the layers are applied, the lower cladding achieves a height ranging from 8 to 12 micrometers. Although the application of three layers are described, those skilled in the art will recognize that more or less than three layers can be used.

After the lower cladding has dried and densified, the polymer core is deposited onto the lower cladding, for example, using the same technique as described above to deposit the lower cladding onto the substrate. However, instead of depositing several sub-layers of the core onto the lower cladding, only one layer of the core is, for example, deposited onto the lower cladding. In one embodiment, the core is soluble in a solvent in which the lower cladding is not soluble so that the solvent does not penetrate the lower cladding and disturb the lower cladding. For a core constructed from poly[2,3-(perfluoroalkenyl) perfluorotetrahydrofuran], solid poly[2,3-(perfluoroalkenyl) perfluorotetrahydrofuran] is dissolved in a solvent, such as perfluorotrialkylamine, which is sold under the trademark CT-SOLV 180™, or any other solvent that readily dissolves polymer, forming a polymer solution. Alternatively, poly[2,3-(perfluoroalkenyl) perfluorotetrahydrofuran] can be commercially obtained already in solution. After the core material is applied and dried, the core film is densified using a low temperature baking process. After the core is dried, a thickness of the core and lower cladding is, for example, ranging approximately from 12 to 16 microns.

Next, the core is etched to provide a desired core shape. For example, the etching is performed by RIE, which is well known in the art. However, those skilled in the art will also recognize that other methods of etching the core may also be used. While FIG. 7 discloses a generally straight core, those skilled in the art will recognize that other shapes can be used, such as the curved waveguide shape disclosed in a commonly assigned U.S. patent application Ser. No. 09/877,871, filed Jun. 8, 2001, which is incorporated herein by reference in its entirety. Further, while FIG. 7 discloses a generally rectangular cross section for the core, those skilled in the art will recognize that the cross section of the core can be other shapes as well.

Next, the upper cladding is deposited onto the core, the core layer, and any remaining portion of the lower cladding not covered by the core or the core layer. For example, similar to the lower cladding, the upper cladding is spincoated in layers, such that a first layer is applied to the core and a remaining portion of the lower cladding layer not covered by the core, baked to evaporate the solvent, and annealed to densify the polymer, a second layer is applied to the first layer, baked and densified, and a third layer is applied to the second layer, baked, and densified. In one embodiment, the upper cladding is soluble in a solvent in which the core and core layer are not soluble so that the solvent does not penetrate the core and the core layer and disturb the core or the core layer. For example, after all of the layers are applied, the entire waveguide achieves a height ranging approximately from 15 to 50 micrometers. Although the application of three layers are described, those skilled in the art will recognize that more or less than three layers can be used. Alternatively, the upper cladding can be a different material from the lower cladding, but with approximately the same refractive index as the lower cladding, for example, a photocuring fluorinated acrylate or a thermoset.

The layers are not necessarily flat, but contour around the core with decreasing curvature for each successive layer. Although the last layer is shown with a generally flat top surface, those skilled in the art will recognize that the top surface of the last layer need not necessarily be flat. Those skilled in the art will also recognize that single layer claddings with high degrees of flatness or planarization can be achieved by either spincoating or casting processes.

After forming the waveguide, the waveguide is cut to a desired size and shape, for example, by dicing. A desired shape is generally rectangular, although those skilled in the art will recognize that the waveguide can be cut to other shapes as well.

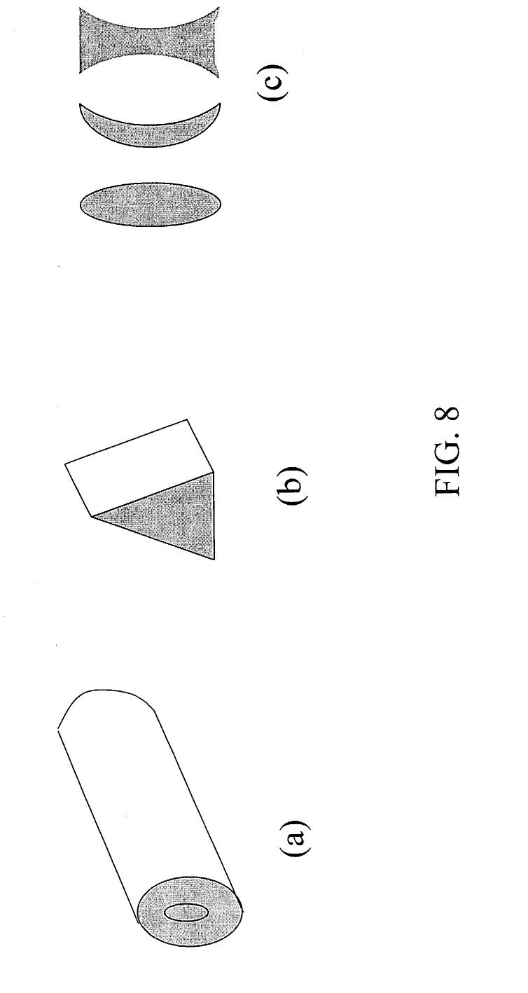

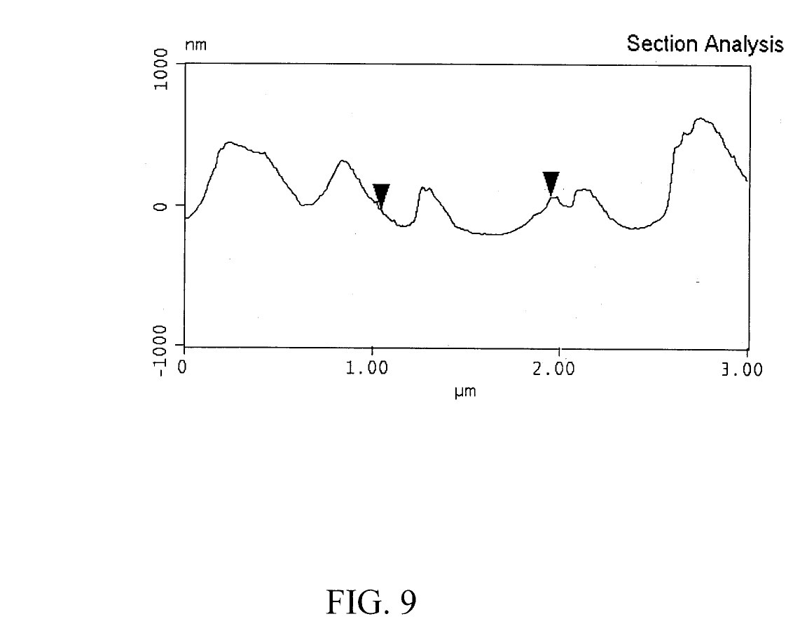

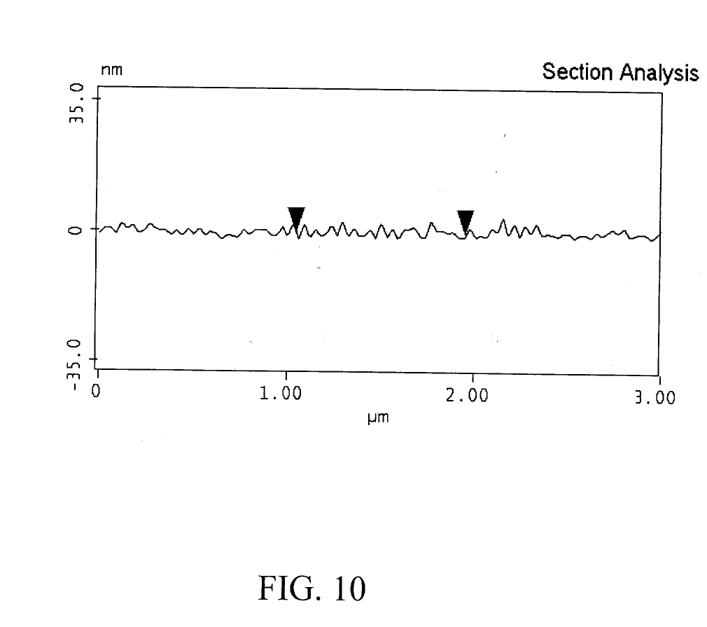

Other examples of optical components that can be made with the disclosed nanoporous materials processing method include, but are not limited to: optical fibers, optical prisms, optical lenses, optical anti-reflection coatings and optical band-pass thin film filters, as illustrated in the FIGS. 8(a) through 8(c).

Optical fibers, as illustrated in FIG. 8(a), can be made by fabricating the fiber preform, drawing fiber from the preform, and generating nanoporous structures inside the fiber by densification and other methods. Alternatively, optical fibers can be fabricated from nanoporous materials by extrusion methods. Bulk optical components, as illustrated in FIGS. 8(b) and 8(c), such as optical prisms, optical lenses, optical storage diskettes, etc., can be made with nanoporous materials by injection molding, casting, extrusion, etc. Optical thin film band-pass filters and anti-reflection coatings can be fabricated from nanoporous materials by extrusion, casting, spin-coating, etc.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

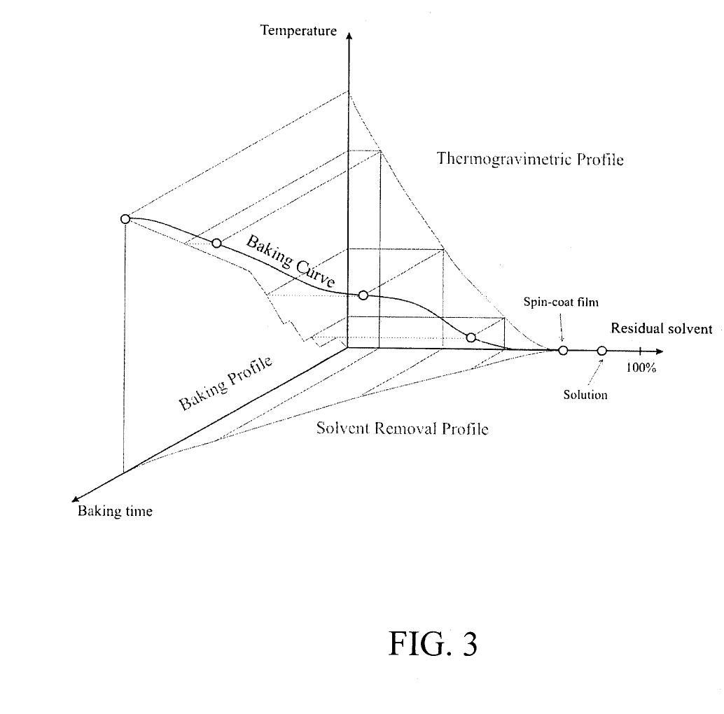

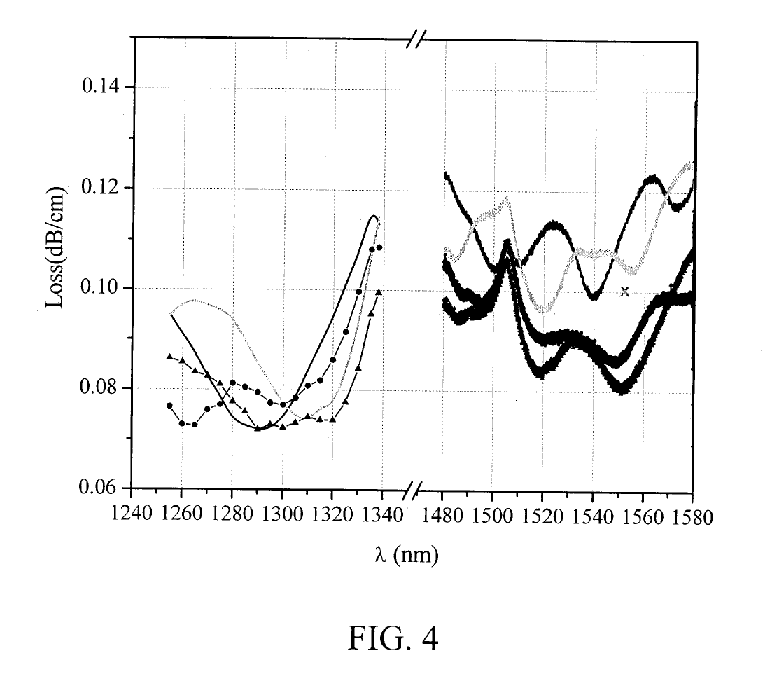

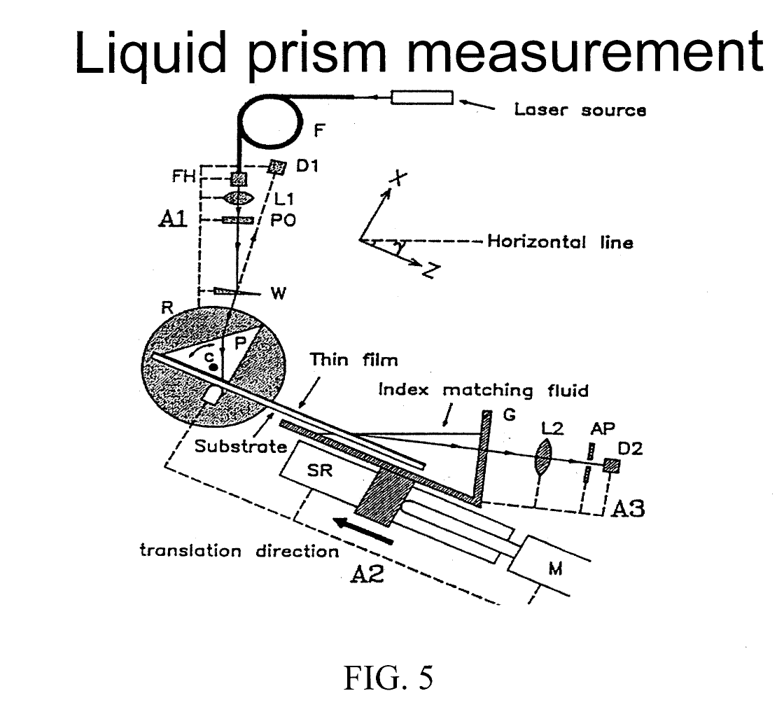

The densification process according to the present invention comprises: baking the polymer to remove the solvent after spin coating, and annealing the wafer at temperatures above the glass transition temperature of the waveguide material, yet below the glass transition temperature or melting temperature of the substrate. For example, the solvent removal baking is performed with a ramped temperature increase profile, which can comprise multiple steps of constant temperatures, or a continuously increasing temperature. The total time required for the solvent removal process is, for example, in the range of 30 minutes to 24 hours. The annealing process follows immediately after the solvent removal process, and the temperature is kept above the waveguide polymer glass transition temperature for a period ranging, for example, from 1 to 48 hours. The annealing profile can be optimized by monitoring the solvent removal by the thermal-gravimetric method, as illustrated in FIG. 3.

The densificatibn process can also be applied to other types of devices and device processes, which may not involve a solvent or a substrate. These processes include, but are not limited to: polymer casting, injection molding, extrusion, hot-stamping, fiber drawing, etc. In these applications, a densification step is performed during the device fabrication processes. The densification can be carried out, for example, by annealing the polymer above its glass transition temperature, but below its decomposition temperature, for a period of time, such as ranging from 1 hour to 48 hours.

The invention is illustrated in greater detail in the examples that follow.

### EXAMPLE 1

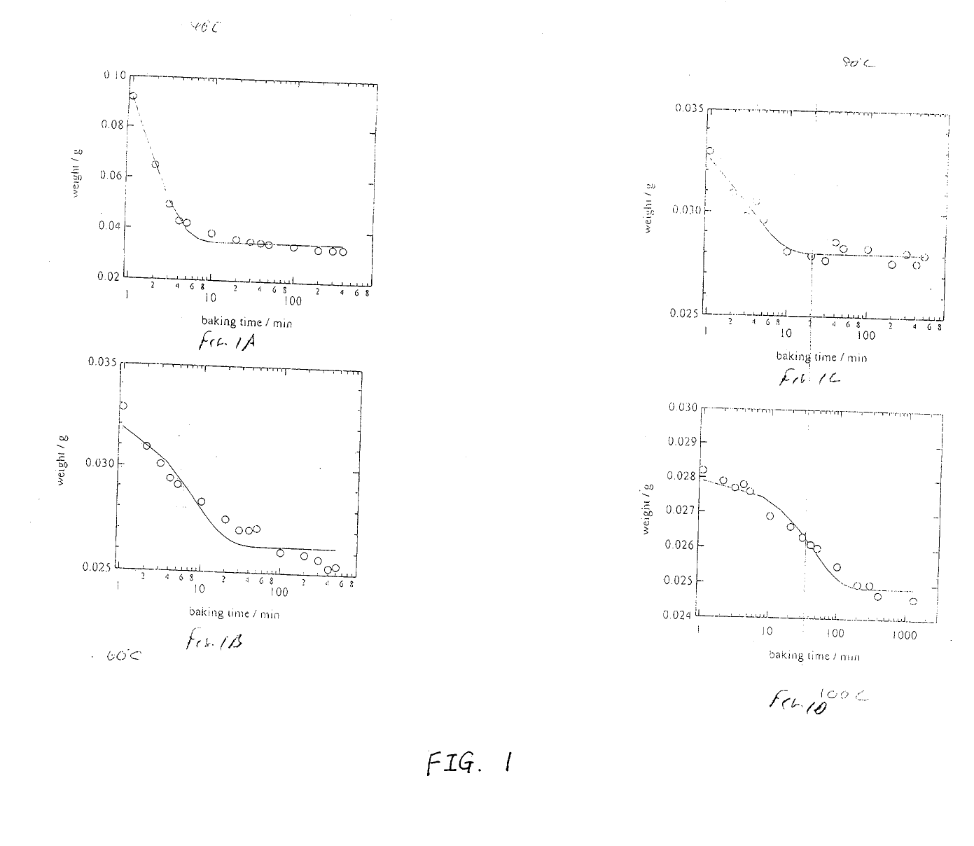

A fluoropolymer solution containing 15% by weight of poly(cyclo-perfluorobutenyl vinyl ether) (Tg=106° C.) and 85% by weight of FC-40 (perfluorotrialkyl amine, bp=155° C.) was spincoated onto a Si wafer. Immediately after spin coating, the resulting fluoropolymer film retained a residual amount of solvent. The film was then further dried on a hot plate and the solvent weight loss was measured gravimetrically at baking temperature of 40° C., 60° C., 80° C., and 100° C., respectively (FIGS. 1A-1D). From these results, an optimal annealing procedure was determined as follows.

1. Anneal at 40° C. for 30 minutes and then at a rate of 2° C./min ramp up to 60° C.;

2. Anneal at 60° C. for 30 minutes and then at a rate of 2° C./min ramp up to 80° C.;

3. Anneal at 80° C. for 30 minutes and then at a rate of 2° C./min ramp up to 100° C.; and

4. Anneal at 100° C. for 2 hours.

Approximately 97% of the solvent was removed from the film below its Tg (106° C.) by using this annealing procedure.

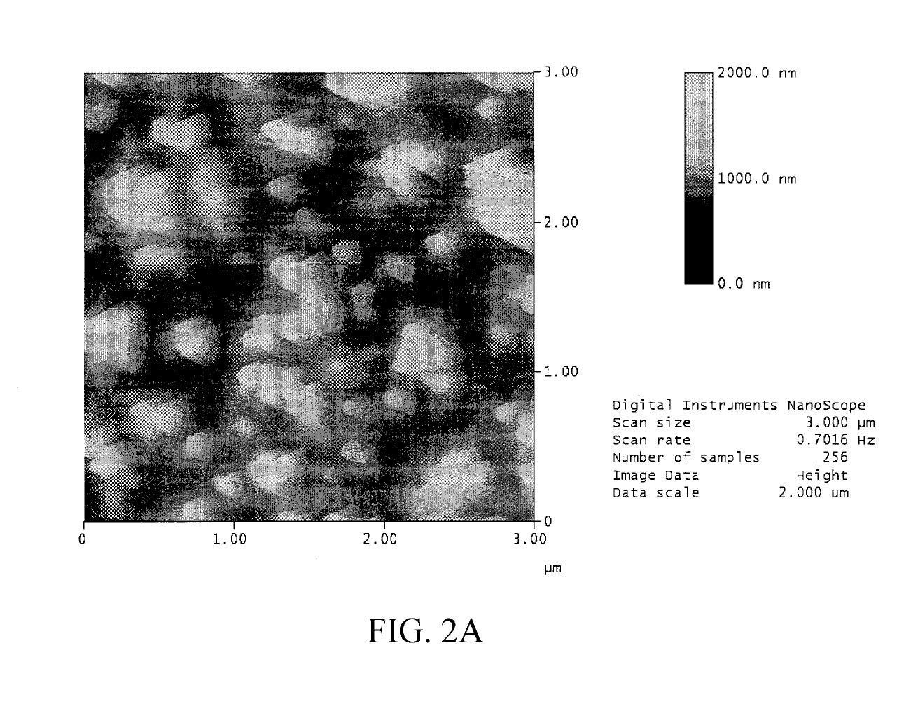

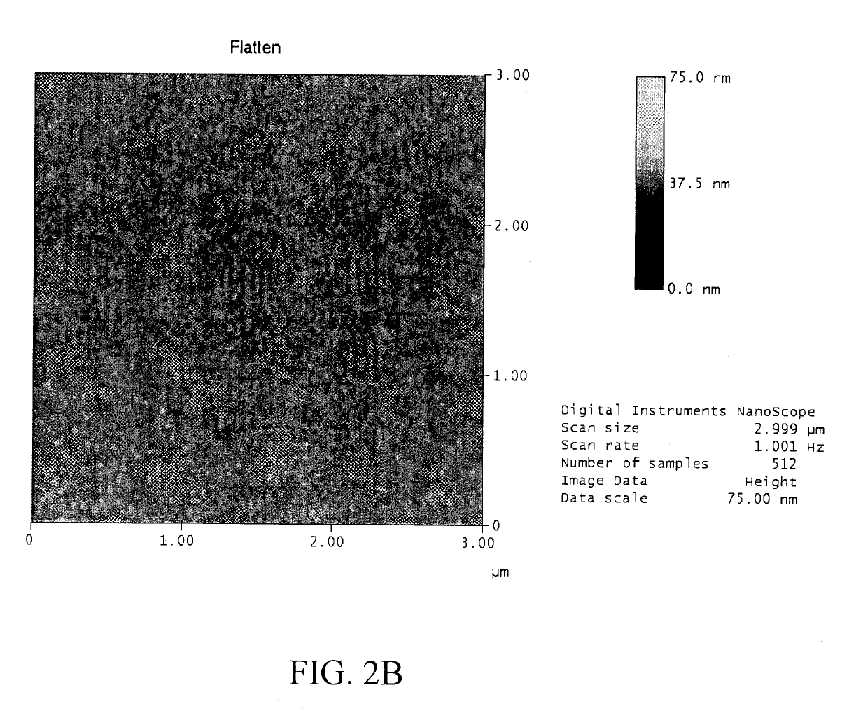

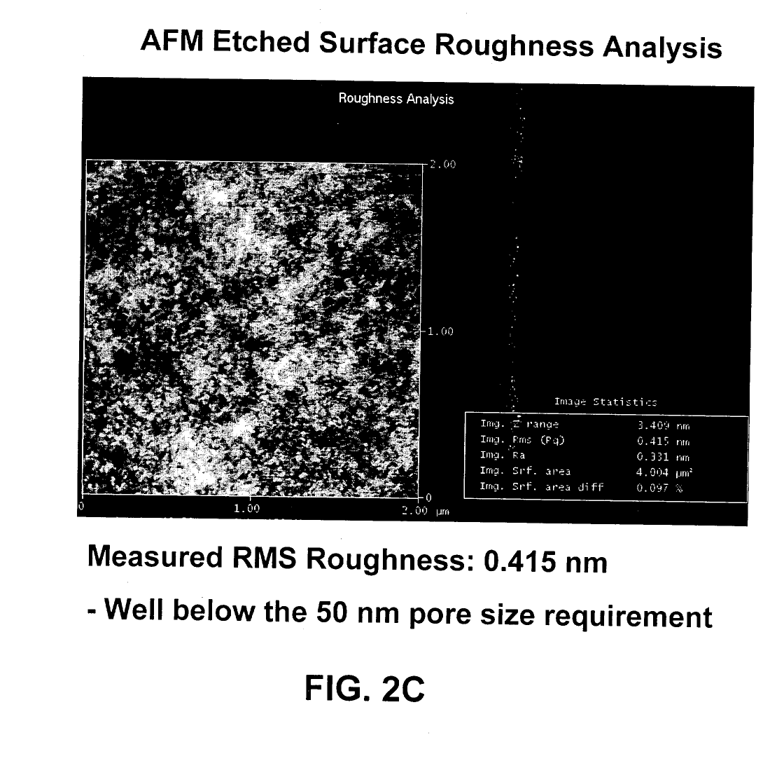

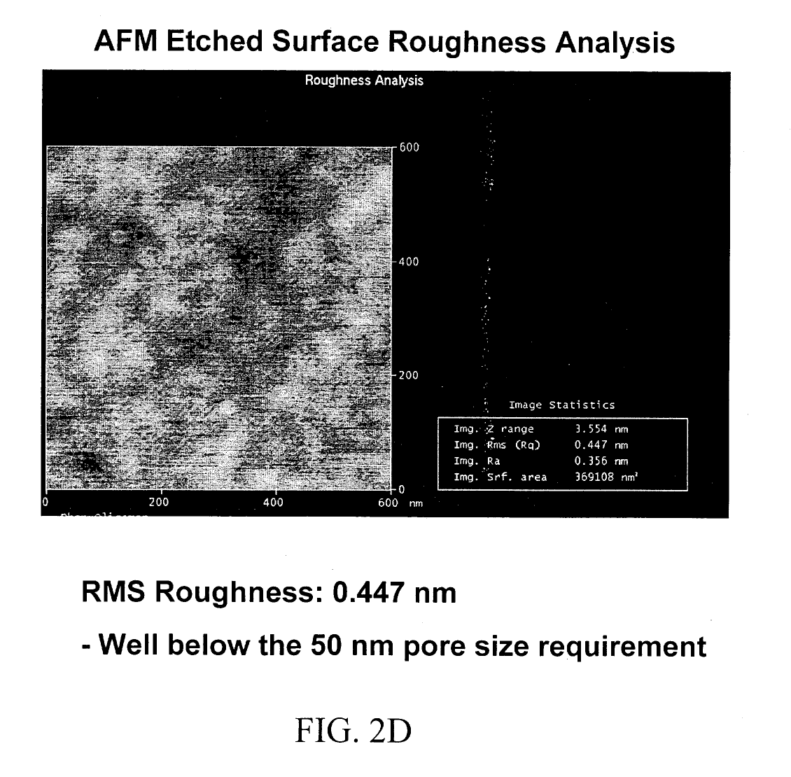

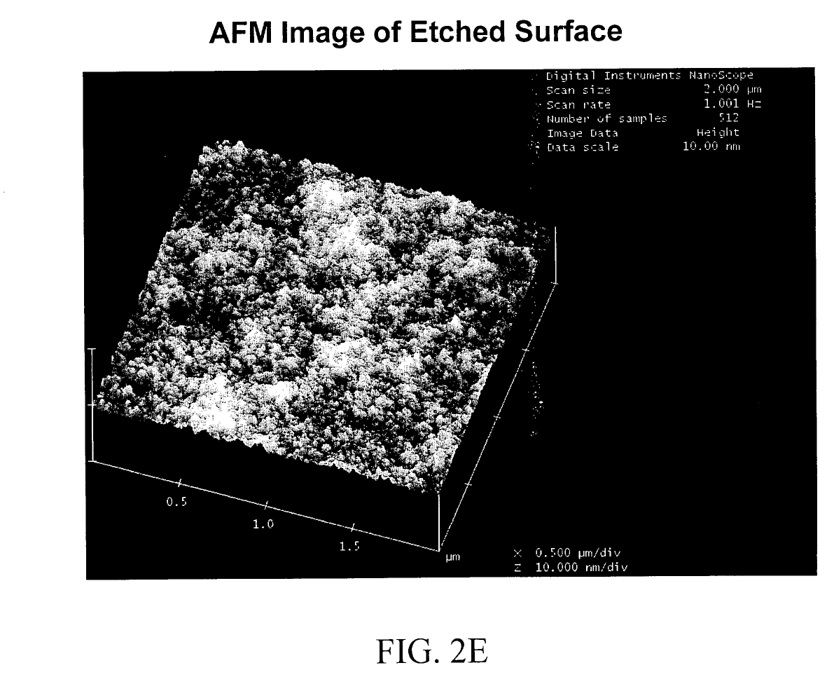

The film was subsequently annealed at appropriate temperatures to further remove trace amounts of residual solvent and induce densification. Upon annealing at 120° C. for 1 hour and then 140° C. for 1 hour, approximately 99.5% of the solvent was removed. The film was further annealed at 160° C. for 1 hour and finally at 180° C. for 1 hour. The film densification after annealing at 120° C., 140° C., 160° C., and 180° C., respectively, was evaluated by Atomic Force Microscopy (AFM). Fluoropolymer films annealed at 120° C., 140° C., and 160° C. displayed interconnected nanoporous network features, as illustrated by the AFM image in FIG. 2A. However, as illustrated in FIGS. 2B and 2C, the thin film sample annealed at 180° C. showed a densified structure wherein the interconnected nanoporous network was controllably changed to a plurality of separate, distinct, nanopores less than 50 nm in diameter as is desired for minimizing optical scattering loss, for example, in waveguides made of the polymer thin film material.

### EXAMPLE 2

A fluoropolymer solution containing 16% by weight of poly(cyclo-perfluorobutenyl vinyl ether) (Tg=106° C.) and 84% by weight of CT-Solv 180 (perfluorotrialkyl amine, bp=180° C.) was spin-coated onto a silicon wafer. Immediately after spin coating, the resulting fluoropolymer film retained a residual amount of solvent. The film was then further dried on a hot plate. The film was densified using the following annealing conditions.

1. Anneal at 40° C. for 30 minutes and then at a rate of 2° C./min ramp up to 60° C.;

2. Anneal at 60° C. for 30 minutes and then at a rate of 2° C./min ramp up to 80° C.;

3. Anneal at 80° C. for 30 minutes and then at a rate of 2° C./min ramp up to 100° C.;

4. Anneal at 100° C. for 1 hour and then at a rate of 2° C./min ramp up to 130° C.; and

5. Anneal at 130° C. for 12 hours.

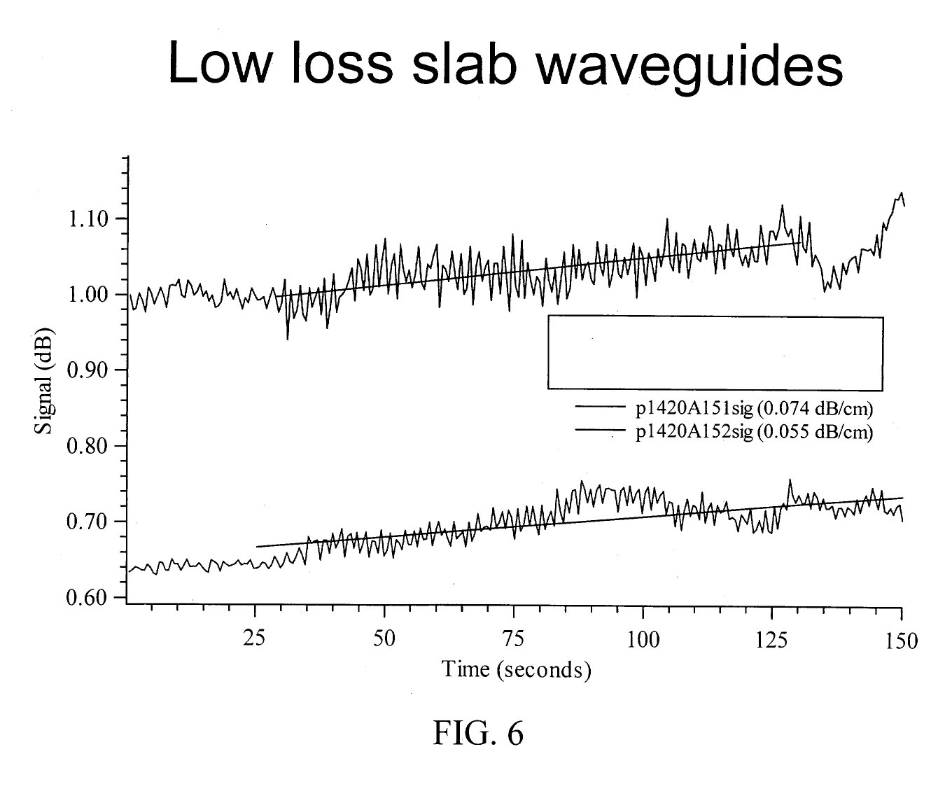

An AFM image of the resulting thermally annealed thin film is shown in FIG. 2D, illustrating the densely packed plurality of separate, distinct, individual nanopores less than 50 nm in diameter as required for minimizing optical scattering loss, for example, in waveguides made of the thin film materials. As an example, the relatively low loss of less than 0.1 dB/cm is demonstrated in FIG. 6 by the 1550 nm data measured in planar slab waveguides following the procedure of the present invention.

### EXAMPLE 3

A fluoropolymer solution containing 16% by weight of poly(cyclo-perfluorobutenyl vinyl ether) (Tg=106° C.) and 84% by weight of CT-Solv 180 (perfluorotrialkyl amine, bp=180° C.) was spin-coated onto a silicon wafer. Immediately after spin coating, the resulting fluoropolymer film retained a residual amount of solvent. The film was then further dried on a hot plate. The film was annealed using the following annealing conditions.

1. Anneal at 40° C. for 30 minutes and then at a rate of 2° C./min ramp up to 60° C.;

2. Anneal at 60° C. for 30 minutes and then at a rate of 2° C./min ramp up to 80° C.;

3. Anneal at 80° C. for 30 minutes and then at a rate of 2° C./min ramp up to 100° C.;

4. Anneal at 100° C. for 1 hour and then at a rate of 2° C./min ramp up to 130° C.; and

5. Anneal at 130° C. for 24 hours.

An AFM image of the resulting thermally annealed thin film is shown in FIG. 2E, illustrating the densely packed plurality of separate, distinct, individual nanopores less than 50 nm in diameter as required for minimizing optical scattering loss, for example, in waveguides made of the thin film materials.

What is claimed is:

1. A random glassy polymer material, wherein the polymer material contains pores with dimensions ranging from about 1 nm to about 100 nm.

2. The material according to claim 1, wherein the pores have dimensions ranging from about 1 nm to about 50 nm.

3. The material according to claim 1, wherein the polymer material is a perhalogenated polymer.

4. The material according to claim 1, wherein the polymer material is a perfluorinated polymer.

5. The material according to claim 1, wherein the polymer material is an amorphous perfluorinated polymer.

6. A process of making an nanoporous random glassy polymer according to claim 1, comprising annealing the polymer at temperatures above a glass transition temperature.

7. A process of making an nanoporous random glassy polymer according to claim 6, wherein said polymer is a perhalogenated polymer.

8. An optical device made from materials according to claim 1, wherein the optical device is a planar optical waveguide.

9. An planar optical waveguie according to claim 8, wherein the planar optical waveguide exhibit a loss of less than 0.5 dB/cm.

10. An planar optical waveguide according to claim 8, wherein the planar optical waveguide is fabricated on a polymer substrate.

11. An planar optical waveguie according to claim 8, wherein the planar optical waveguide is fabricated with perfluorinated polymers.

12. An optical device made from materials according to claim 1, wherein the optical device is an optical prism.

13. An optical device made from materials according to claim 1, wherein the optical device is an optical lens.

14. An optical device made from materials according to claim 1, wherein the optical device is an optical thin film.
